(19) United States
(12) Patent Application Publication
(10) Pub. No.: US 2026/0225464 A1
(43) Pub. Date: Aug. 6, 2026

(54) Intelligent Power Train Control Based on Map Information

(71) Applicant: Nissan North America, Inc., Franklin, TN (US)

(72) Inventors: Corey Heath, Scottsdale, AZ (US); Stefan Witwicki, San Carlos, CA (US); Atsushi Kasuya, Los Altos Hills, CA (US)

(21) Appl. No.: 19/044,003

(22) Filed: Feb. 3, 2025

(51) Int. Cl. B60L 15/20

(52) U.S. Cl. CPC B60L 15/2045; B60L 2240/12; B60L 2260/40

(57) ABSTRACT

A method includes collecting data from one or more systems of a vehicle, wherein the vehicle comprises a battery. The method also includes obtaining a navigation map that represents a vehicle transportation network in a computer-interpretable form and determining a route for the vehicle. The method also includes determining a target speed for travel of the vehicle along the route based on the navigation map and determining a state of the vehicle, wherein the state of the vehicle comprises the target speed. The method also includes determining, using a decision-making model, whether to use a first a powertrain control mode or a second powertrain control mode based on the state of the vehicle, and setting the vehicle to use one of the first powertrain control mode or the second powertrain control mode.

### TECHNICAL FIELD

This disclosure relates generally to battery electric vehicles, and to intelligent powertrain control for battery electric vehicles based on map information.

### BACKGROUND

A battery electric vehicle (BEV) typically includes an electric motor (powered by an electric battery) to move the vehicle. Additionally, energy recaptured via regenerative braking can be used to recharge the battery. A consideration in the operation of BEVs is the ability to switch to one or more modes that optimize battery efficiency. Sub-optimal use of modes that optimize battery efficiency may result in, for example, wasted energy and/or reduction in the life of the battery.

### SUMMARY

A first aspect of the disclosed implementations is a method. The method comprises collecting data from one or more systems of a vehicle, wherein the vehicle comprises a battery. The method further comprises obtaining a navigation map that represents a vehicle transportation network in a computer-interpretable form and determining a route for the vehicle. The method further comprises determining a target speed for travel of the vehicle along the route based on the navigation map and determining a state of the vehicle, wherein the state of the vehicle comprises the target speed. The method further comprises determining, using a decision-making model, whether to use a first a powertrain control mode or a second powertrain control mode based on the state of the vehicle, wherein the second powertrain control mode reduces a rate of discharge of the battery as compared to the first powertrain control mode. The method further comprises setting the vehicle to use one of the first powertrain control mode or the second powertrain control mode according to the determination by the decision-making model.

A second aspect of the disclosed embodiments is an apparatus. The apparatus includes a memory subsystem and one or more processors that are configured to execute instructions stored in the memory subsystem. The one or more processors execute the instructions to collect data from one or more systems of a vehicle, wherein the vehicle comprises a battery, and obtain a navigation map that represents a vehicle transportation network in a computer-interpretable form. The one or more processors further execute the instructions to determine a route for the vehicle, determine a target speed for travel of the vehicle along the route based on the navigation map, and determine a state of the vehicle, wherein the state of the vehicle comprises the target speed. The one or more processors further execute the instructions to determine, using a decision-making model, whether to use a first a powertrain control mode or a second powertrain control mode based on the state of the vehicle, wherein the second powertrain control mode reduces a rate of discharge of the battery as compared to the first powertrain control mode. The one or more processors further execute instructions to set the vehicle to use one of the first powertrain control mode or the second powertrain control mode according to the determination by the decision-making model.

A third aspect of the disclosed embodiments is a non-transitory computer-readable storage medium storing instructions operable to cause one or more processors to perform operations. The operations comprise collecting data from one or more systems of a vehicle, wherein the vehicle comprises a battery, obtaining a navigation map that represents a vehicle transportation network in a computer-interpretable form, and determining a route for the vehicle. The operations further comprise determining a target speed for travel of the vehicle along the route based on the navigation map, and determining a state of the vehicle, wherein the state of the vehicle comprises the target speed. The operations further comprise determining, using a decision-making model, whether to use a first a powertrain control mode or a second powertrain control mode based on the state of the vehicle, wherein the second powertrain control mode reduces a rate of discharge of the battery as compared to the first powertrain control mode. The operations further comprise setting the vehicle to use one of the first powertrain control mode or the second powertrain control mode according to the determination by the decision-making model.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The various aspects of the methods and apparatuses disclosed herein will become more apparent by referring to the examples provided in the following description and drawings in which like reference numbers refer to like elements.

FIG. 1 is a diagram of an example of a vehicle.

FIG. 2 is a diagram of an example of a portion of a vehicle transportation and communication system.

FIG. 3 is a diagram of a powertrain for a battery electric vehicle, including a control module.

FIG. 4A is a diagram of a planner that is implemented by the control module of FIG. 3.

FIGS. 4B-4C are graphs that illustrate relationships between an accelerator pedal state and a resulting motor output.

FIG. 5 is a diagram of powertrain control planning according to an example.

FIG. 6 is a diagram of an example of travel on a transportation network.

FIG. 7 is a diagram showing an example of determination of a target speed.

FIG. 8 is a diagram of an example of a process for determination of a powertrain control decision.

### DETAILED DESCRIPTION

As mentioned above, a battery electric vehicle (BEV) typically includes an electric battery. A consideration with battery electric engines is use of a mode that prioritizes energy efficiency, which is referred to herein as eco mode. In eco mode a rate of acceleration is limited when the accelerator pedal is pressed as opposed to operation in other modes. This may be accomplished by changing an accelerator input-output mapping that relates the degree of operation of the accelerator pedal to the desired motor output (e.g., output torque) of the electric motor of the vehicle. Thus, for example, eco mode may be associated with a first accelerator input-output mapping while another mode, such as a standard mode, a sport mode, or another mode, may be associated with a second accelerator input-output mapping.

Described herein are systems and techniques for intelligent powertrain control using map information. A BEV includes a powertrain control planner, which may be referred to herein as a planner. The planner determines (e.g., calculates, predicts, etc.) a powertrain control policy for a vehicle (e.g., a BEV). Using the powertrain control policy, the planner can make decisions regarding powertrain control, such as whether to modify the accelerator input-output mapping. These decisions are referred to herein as powertrain control decisions or as control decisions. It should be understood that an eco mode activation decision (e.g., determining to turn the eco mode on or off) is a type of powertrain control decision because transition between the eco mode and a different mode includes a modification of the accelerator input-output mapping.

In some BEV systems, simple eco mode activation rules may be employed. For example, eco mode activation may be based on the state-of-charge (SoC) of the battery under different conditions. To illustrate, a policy may simply attempt to conserve battery life if a charge of the battery falls below a threshold percentage (e.g., 20%). For example, if the charge of the charge of the battery falls below 20%, then the eco mode can be turned on to conserve the remaining battery life. While simple, such eco mode activation approaches (referred to herein as hard-coded rules) are brittle and cannot benefit from predictions.

As further described below, the powertrain control policy can be optimized for many different types of objectives. For example, the powertrain control policy can change a balance between an efficiency objective and a performance objective.

The powertrain control policy may be determined in part from patterns of behavior. The patterns of behavior can be based on patterns of behavior of a single driver (e.g., the current driver of the vehicle), patterns of behavior of different drivers of the same vehicle (e.g., one may drive more conservatively and another may drive less conservatively), patterns of behavior of drivers within a region (e.g., some or all drivers/vehicles within the region for which data is available), other patterns of behavior, or a combination thereof. Patterns of behavior can include information regarding driving style, information regarding routes taken, and/or other types of behavior information.

The systems and techniques described herein utilize information about expected future speeds on the route that the vehicle is travelling on. When the route for the vehicle is known from a navigation system or other source, the powertrain control policy can utilize information about the route to make the powertrain control decisions. When the route is not explicitly known (such as, for example, when a driver gets in the vehicle and starts driving without setting a route), the planner can make the powertrain control decisions based on a probable route by predicting where the driver is likely to go (e.g., to drive to). The probable route may be predicted based on the historical patterns of behaviors from the driver and/or historical patterns of behaviors for current drivers. It should be understood that a probable route may be expressed, for a current or future location of the vehicle, in terms of the probability the each of several possible sections of a transportation network will be the next location of the vehicle. For example, based on the driver's past behavior, the probable route when approaching an intersection may be a 25% chance of a right turn and a 75% chance of a left turn based on previous behavior.

Using information about a route or probable route for the vehicle, including the expected future speeds of the vehicle a powertrain control planner according to implementations of this disclosure can anticipate road sections where a more responsive performance may be beneficial, and temporarily change (e.g., modify, switch) the accelerator input-output mapping to prioritize performance while this road section is traversed. For example, areas in which the expected future speeds of the vehicle correspond to acceleration of the vehicle may include areas subsequent to an intersection or freeway on-ramps. The powertrain control planner can proactively change the powertrain control of the vehicle to provide full access to the acceleration capabilities for such areas by changing from the eco mode to the standard mode or by otherwise changing the accelerator input-output mapping. When the expected future speeds no longer correspond to an area in which acceleration is expected, the vehicle may be returned to eco mode or otherwise reverted to a more efficient version of the input-output mapping.

These and other optimizations can be realized by intelligent powertrain control for battery electric vehicles (BEVs) according to implementations of this disclosure. In an example, powertrain control planning can be modeled as a type of Markov decision process (MDP) such as a multi-objective Markov decision process (MOMDP) problem. The MOMDP model can take a vehicle model and a navigation map as input and generate a powertrain control policy as an output.

Further details of intelligent powertrain control planning are described herein with initial reference to an environment in which the systems and techniques can be implemented.

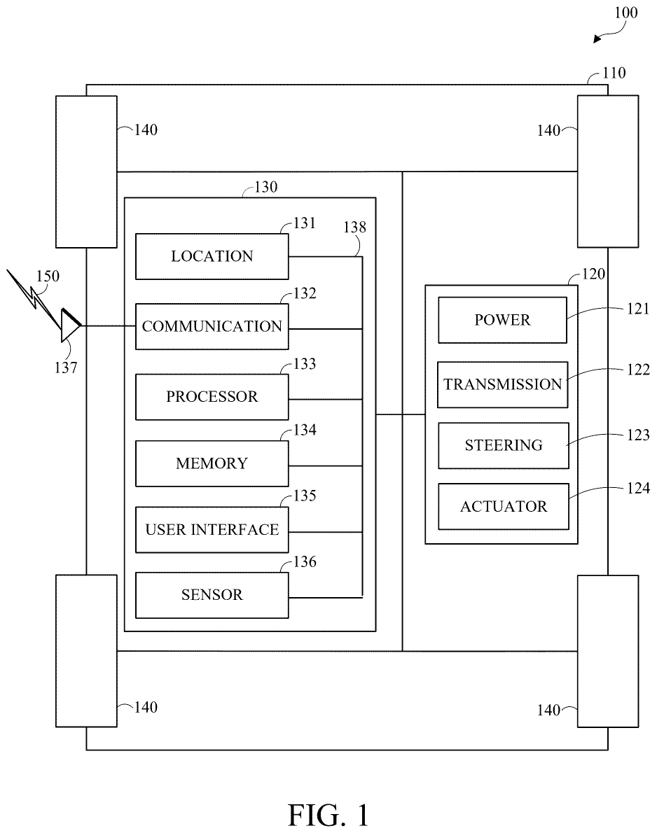

FIG. 1 is a diagram of an example of a vehicle 100 in which the aspects, features, and elements disclosed herein may be implemented. In the embodiment shown, the vehicle 100 includes various vehicle systems, such as a chassis 110, a powertrain 120, a controller 130, and wheels 140. Additional or different combinations of vehicle systems may be used. Although the vehicle 100 is shown as including four wheels 140 for simplicity, other mechanical configurations, such as a propeller or a tread, may be used. In FIG. 1, the lines interconnecting elements, such as the powertrain 120, the controller 130, and the wheels 140, indicate that information, such as data or control signals, power, such as electrical power or torque, or both information and power, may be communicated between the respective elements. For example, the controller 130 may receive power from the powertrain 120 and may communicate with the powertrain 120, the wheels 140, or both, to control the vehicle 100, which may include accelerating, decelerating, steering, or otherwise controlling the vehicle 100.

The powertrain 120 shown by example in FIG. 1 includes a power source 121, a transmission 122, a steering unit 123, and an actuator 124. Any other element or combination of elements of a powertrain, such as a suspension, a drive shaft, axles, or an exhaust system may also be included. Although shown separately, the wheels 140 may be included in the powertrain 120.

The power source 121 includes an engine, a battery, or a combination thereof. The power source 121 may be any device or combination of devices operative to provide energy, such as electrical energy, thermal energy, or kinetic energy. In an example, the power source 121 includes an engine, such as an internal combustion engine, an electric motor, or a combination of an internal combustion engine and an electric motor and is operative to provide kinetic energy as a motive force to one or more of the wheels 140. Alternatively, or additionally, the power source 121 includes a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 122 receives energy, such as kinetic energy, from the power source 121, transmits the energy to the wheels 140 to provide a motive force. The transmission 122 may be controlled by the controller 130, the actuator 124, or both. The steering unit 123 may be controlled by the controller 130, the actuator 124, or both and control the wheels 140 to steer the vehicle. The actuator 124 may receive signals from the controller 130 and actuate or control the power source 121, the transmission 122, the steering unit 123, or any combination thereof to operate the vehicle 100.

In the illustrated embodiment, the controller 130 includes a location unit 131, an electronic communication unit 132, a processor 133, a memory 134, a user interface 135, a sensor 136, and an electronic communication interface 137. Fewer of these elements may exist as part of the controller 130. Although shown as a single unit, any one or more elements of the controller 130 may be integrated into any number of separate physical units. For example, the user interface 135 and the processor 133 may be integrated in a first physical unit and the memory 134 may be integrated in a second physical unit. Although not shown in FIG. 1, the controller 130 may include a power source, such as a battery. Although shown as separate elements, the location unit 131, the electronic communication unit 132, the processor 133, the memory 134, the user interface 135, the sensor 136, the electronic communication interface 137, or any combination thereof may be integrated in one or more electronic units, circuits, or chips.

The processor 133 may include any device or combination of devices capable of manipulating or processing a signal or other information now existing or hereafter developed, including optical processors, quantum processors, molecular processors, or a combination thereof. For example, the processor 133 may include one or more special purpose processors, one or more digital signal processors, one or more microprocessors, one or more controllers, one or more microcontrollers, one or more integrated circuits, one or more Application Specific Integrated Circuits, one or more Field Programmable Gate Array, one or more programmable logic arrays, one or more programmable logic controllers, one or more state machines, or any combination thereof. The processor 133 is operatively coupled with one or more of the location unit 131, the memory 134, the electronic communication interface 137, the electronic communication unit 132, the user interface 135, the sensor 136, and the powertrain 120. For example, the processor may be operatively coupled with the memory 134 via a communication bus 138.

The memory 134 includes any tangible non-transitory computer-usable or computer-readable medium, capable of, for example, containing, storing, communicating, or transporting machine readable instructions, or any information associated therewith, for use by or in connection with any processor, such as the processor 133. The memory 134 may be, for example, one or more solid state drives, one or more memory cards, one or more removable media, one or more read-only memories, one or more random access memories, one or more disks, including a hard disk, a floppy disk, an optical disk, a magnetic or optical card, or any type of non-transitory media suitable for storing electronic information, or any combination thereof. For example, a memory may be one or more read only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

The electronic communication interface 137 may be a wireless antenna, as shown, a wired communication port, an optical communication port, or any other wired or wireless unit capable of interfacing with a wired or wireless electronic communication medium 150. Although FIG. 1 shows the electronic communication interface 137 communicating via a single communication link, a communication interface may be configured to communicate via multiple communication links. Although FIG. 1 shows a single instance of the electronic communication interface 137, the vehicle 100 may include any number of communication interfaces.

The electronic communication unit 132 is configured to transmit or receive signals via a wired or wireless electronic communication medium 150, such as via the electronic communication interface 137. Although not explicitly shown in FIG. 1, the electronic communication unit 132 may be configured to transmit, receive, or both via any wired or wireless communication medium, such as radio frequency (RF), ultraviolet (UV), visible light, fiber optic, wireline, or a combination thereof. Although FIG. 1 shows a single instance of the electronic communication unit 132 and a single instance of the electronic communication interface 137, any number of electronic communication units and any number of electronic communication interfaces may be used. In some embodiments, the electronic communication unit 132 includes a dedicated short-range communications (DSRC) unit, an on-board unit (OBU), or a combination thereof.

The location unit 131 may determine geolocation information, such as longitude, latitude, elevation, direction of travel, or speed, of the vehicle 100. For example, the location unit includes a global navigation satellite system (GNSS) unit (e.g., a global positioning system (GPS) unit), a wide area augmentation system (WAAS) enabled National Marine-Electronics Association (NMEA) unit, a radio triangulation unit, or a combination thereof. The location unit 131 can be used to obtain information that represents, for example, a current heading of the vehicle 100, a current position of the vehicle 100 in two or three dimensions, a current angular orientation of the vehicle 100, or a combination thereof.

The user interface 135 includes any unit capable of interfacing with a person, such as a virtual or physical keypad, a touchpad, a display, a touch display, a heads-up display, a virtual display, an augmented reality display, a haptic display, a feature tracking device, such as an eye-tracking device, a speaker, a microphone, a video camera, a sensor, a printer, or any combination thereof. The user interface 135 may be operatively coupled with the processor 133, as shown, or with any other element of the controller 130. Although shown as a single unit, the user interface 135 may include one or more physical units. For example, the user interface 135 may include both an audio interface for performing audio communication with a person and a touch display for performing visual and touch-based communication with the person. The user interface 135 may include multiple displays, such as multiple physically separate units, multiple defined portions within a single physical unit, or a combination thereof.

The sensor 136 is operable to provide information that may be used to control the vehicle. The sensor 136 may include multiple sensors or the sensor 136 may be an array of sensors. The sensor 136 may provide information regarding current operating characteristics of the vehicle 100, including vehicle operational information. The sensor 136 can include, for example, a speed sensor, acceleration sensors, a steering angle sensor, traction-related sensors, braking-related sensors, steering wheel position sensors, eye tracking sensors, seating position sensors, or any sensor, or combination of sensors, which are operable to report information regarding some aspect of the current dynamic situation of the vehicle 100.

The sensor 136 may include one or more sensors that are operable to obtain information regarding the physical environment surrounding the vehicle 100, such as operational environment information. For example, one or more sensors may detect road geometry, such as lane lines, and obstacles, such as fixed obstacles, vehicles, and pedestrians. The sensor 136 can be or include one or more video cameras, laser-sensing systems, infrared-sensing systems, acoustic-sensing systems, or any other suitable type of on-vehicle environmental sensing device, or combination of devices, now known or later developed. In some embodiments, the sensor 136 and the location unit 131 are combined.

Although not shown separately, the vehicle 100 may include a trajectory controller. For example, the controller 130 may include the trajectory controller. The trajectory controller may be operable to obtain information describing a current state of the vehicle 100 and a route planned for the vehicle 100, and, based on this information, to determine and optimize a trajectory for the vehicle 100. In some embodiments, the trajectory controller may output signals operable to control the vehicle 100 such that the vehicle 100 follows the trajectory that is determined by the trajectory controller. For example, the output of the trajectory controller can be an optimized trajectory that may be supplied to the powertrain 120, the wheels 140, or both. In some embodiments, the optimized trajectory can be or include one or more control inputs such as a set of steering angles, with each steering angle corresponding to a point in time or a position. In some embodiments, the optimized trajectory can be one or more paths, lines, curves, or a combination thereof.

One or more of the wheels 140 may be a steered wheel that is pivoted to a steering angle under control of the steering unit 123, a propelled wheel that is torqued to propel the vehicle 100 under control of the transmission 122, or a steered and propelled wheel that may steer and propel the vehicle 100.

Although not shown in FIG. 1, the vehicle 100 may include additional units or elements not shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or any combination thereof.

The vehicle 100 may be an autonomous vehicle that is controlled autonomously, without direct human intervention, to traverse a portion of a vehicle transportation network. Although not shown separately in FIG. 1, an autonomous vehicle may include an autonomous vehicle control unit that performs autonomous vehicle routing, navigation, and control. The autonomous vehicle control unit may be integrated with another unit of the vehicle. For example, the controller 130 may include the autonomous vehicle control unit.

When present, the autonomous vehicle control unit may control or operate the vehicle 100 to traverse a portion of the vehicle transportation network in accordance with current vehicle operation parameters. The autonomous vehicle control unit may control or operate the vehicle 100 to perform a defined operation or maneuver, such as parking the vehicle. The autonomous vehicle control unit may generate a route of travel from an origin, such as a current location of the vehicle 100, to a destination based on vehicle information, environment information, vehicle transportation network information representing the vehicle transportation network, or a combination thereof, and may control or operate the vehicle 100 to traverse the vehicle transportation network in accordance with the route. For example, the autonomous vehicle control unit may output the route of travel to the trajectory controller to operate the vehicle 100 to travel from the origin to the destination using the generated route.

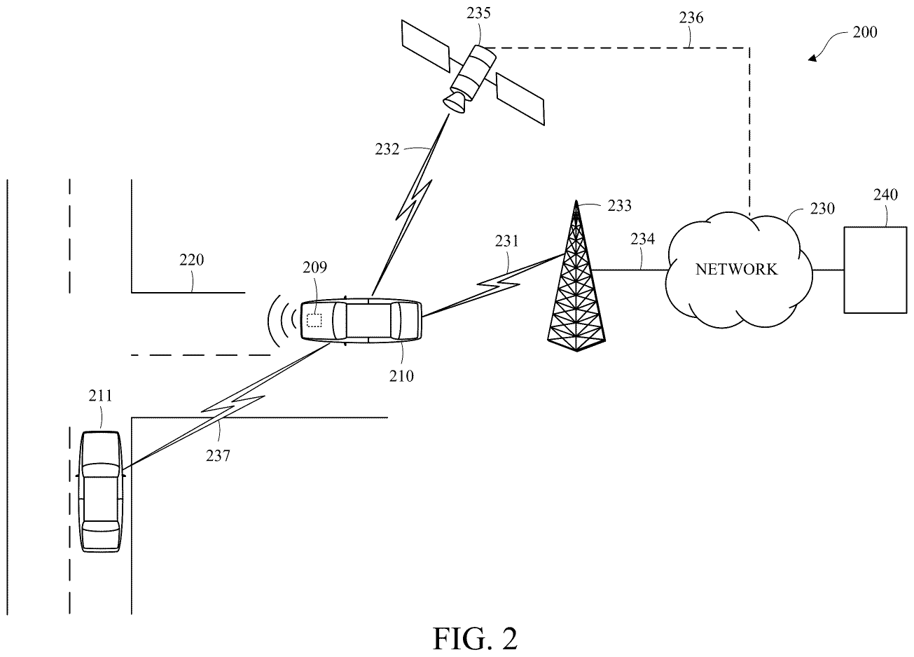

FIG. 2 is a diagram of an example of a portion of a vehicle transportation and communication system 200 in which the aspects, features, and elements disclosed herein may be implemented. The vehicle transportation and communication system 200 may include one or more vehicles, such as a host vehicle 210, and remote vehicle 211, and/or other vehicles. The host vehicle 210 and the remote vehicle 211 may be implemented according to the description of the vehicle 100 of FIG. 1.

The host vehicle 210 and the remote vehicle 211 are configured to travel via one or more portions of the vehicle transportation network 220. The portions of the vehicle transportation network that are traversed by the host vehicle 210 and the remote vehicle 211 may include public roadways such as non-limited access roadways and limited access roadways. Although not explicitly shown in FIG. 2, the host vehicle 210, the remote vehicle 211, and/or other vehicles may traverse an off-road area.

The host vehicle 210 and the remote vehicle 211 are also configured to communicate with each other. Communications between the host vehicle 210 and the remote vehicle 211 may be established via a wired communication link, a wireless communication link, or a combination any number of wired or wireless communication links. As shown, the host vehicle 210 and the remote vehicle 211 communicate via a terrestrial wireless communication link 231, via a non-terrestrial wireless communication link 232, via a direct communication link 237, or via a combination thereof.

The communications between the host vehicle 210, the remote vehicle 211, and/or other devices and systems may be facilitated by an electronic communication network 230. The electronic communication network 230 may be, for example, a multiple access system that provides for communication, such as voice communication, data communication, video communication, messaging communication, or a combination thereof, between the host vehicle 210 or the remote vehicle 211 and a communication device 240 (e.g., one or more communication devices). The communication device 240 may be servers, infrastructure-based sensors, or other computer-implemented systems that are configured to provide information to the host vehicle 210 or the remote vehicle 211. For example, the host vehicle 210 or the remote vehicle 211 may receive information, such as information representing the vehicle transportation network 220, from the communication device 240 via the electronic communication network 230.

The electronic communication network 230 is any type of network configured to provide for voice communication, data communication, or any other type of electronic communication. For example, the electronic communication network 230 may include a local area network (LAN), a wide area network (WAN), a virtual private network (VPN), a mobile or cellular telephone network, the Internet, or any other electronic communication system. The electronic communication network 230 uses a communication protocol, such as the transmission control protocol (TCP), the user datagram protocol (UDP), the internet protocol (IP), the real-time transport protocol (RTP) the HyperText Transport Protocol (HTTP), or a combination thereof. Although shown as a single unit here, an electronic communication network may include any number of interconnected elements.

The terrestrial wireless communication link 231 is a wireless communication channel established between a vehicle, such as the host vehicle 210 or the remote vehicle 211, and an access point 233. The terrestrial wireless communication link 231 may include an Ethernet link, a serial link, a Bluetooth link, an infrared (IR) link, an ultraviolet (UV) link, or any link capable of providing for electronic communication. The access point 233 is a terrestrial structure, such as a radio frequency band antenna, and may include a computing device. The access point 233 is configured to communicate with the host vehicle 210, the electronic communication network 230, and/or the communication device 240 using the terrestrial wireless communication link 231, a wired communication link 234, or a combination thereof. For example, the access point 233 may be a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit here, the access point 233 may include any number of interconnected elements.

The non-terrestrial wireless communication link 232 is a wireless communication channel established between the host vehicle 210 or the remote vehicle 211 and a non-terrestrial communication device, such as a satellite 235. The satellite 235, which may include a computing device, is configured to communicate with the host vehicle 210, with the remote vehicle 211, with the electronic communication network 230, with the communication device 240, or with a combination thereof via one or more communication links such as the non-terrestrial wireless communication link 232 or a communication link 236 between the satellite 235 and the electronic communication network 230. Although shown as a single unit here, the satellite 235 may include any number of interconnected elements.

Communications between the host vehicle 210 and the remote vehicle 211 may include one or more automated inter-vehicle messages, such as a basic safety message (BSM). For example, an automated inter-vehicle message may be transmitted by the remote vehicle 211 and received by the host vehicle 210. The automated inter-vehicle message may be transmitted and received via the electronic communication network 230 using the terrestrial wireless communication link 231 or the non-terrestrial wireless communication link 232. Alternatively, or in addition, the automated inter-vehicle message may be transmitted and received via the direct communication link 237. For example, the remote vehicle 211 may broadcast the message to other vehicles (including the host vehicle 210) within a defined broadcast range, such as 300 meters. In some embodiments, the host vehicle 210 may receive a message via a third party, such as a signal repeater (not shown) or another remote vehicle (not shown). A vehicle such as the host vehicle 210 or the remote vehicle 211 may transmit one or more automated inter-vehicle messages periodically, based on, for example, a defined interval, such as 100 milliseconds.

Automated inter-vehicle messages may include vehicle identification information, geospatial state information, such as longitude, latitude, or elevation information, geospatial location accuracy information, kinematic state information, such as vehicle acceleration information, yaw rate information, speed information, vehicle heading information, braking system status information, throttle information, steering wheel angle information, or vehicle routing information, or vehicle operating state information, such as vehicle size information, headlight state information, turn signal information, wiper status information, transmission information, or any other information, or combination of information, relevant to the transmitting vehicle state. For example, transmission state information may indicate whether the transmission of the transmitting vehicle is in a neutral state, a parked state, a forward state, or a reverse state.

The host vehicle 210 may identify a portion of the vehicle transportation network 220 or a condition of the vehicle transportation network 220. For example, the vehicle includes an on-vehicle sensor 209 (e.g., one or more on-vehicle sensors) that may be implemented in the manner described with respect to the sensor 136 of FIG. 1. As examples, the on-vehicle sensor 209 may be or include a speed sensor, a wheel speed sensor, a camera, a gyroscope, an optical sensor, a laser sensor, a radar sensor, a sonic sensor, or any other sensor or device or combination thereof capable of determining or identifying a portion or condition of the vehicle transportation network 220.

The host vehicle 210 may traverse a portion or portions of the vehicle transportation network 220 using information communicated via the electronic communication network 230, such as information representing the vehicle transportation network 220, information identified by the on-vehicle sensor 209, or a combination thereof.

Although FIG. 2 shows one instance of the vehicle transportation network 220, one instance of the electronic communication network 230, and one instance of the communication device 240 for simplicity, any number of networks or communication devices may be used. The vehicle transportation and communication system 200 may include devices, units, or elements not shown in FIG. 2. Although the host vehicle 210 is shown as a single unit, a vehicle may include any number of interconnected elements.

Although the host vehicle 210 is shown communicating with the communication device 240 via the electronic communication network 230, the host vehicle 210 may communicate with the communication device 240 via any number of direct or indirect communication links. For example, the host vehicle 210 may communicate with the communication device 240 via a direct communication link, such as a Bluetooth communication link.

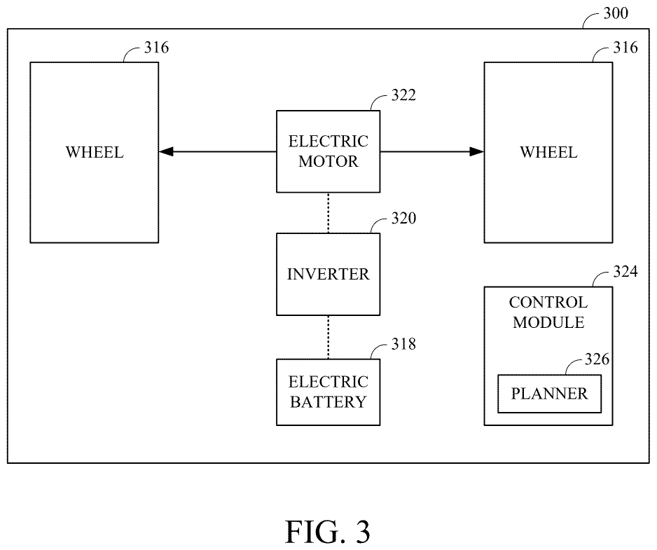

FIG. 3 is a diagram of a powertrain 300 for a BEV in which the aspects, features, and elements disclosed herein may be implemented. Implementations of powertrain control planning according to implementations of this disclosure can be implemented in BEV systems including those described with respect to FIG. 3. In some implementations, the powertrain 300 may be incorporated in the vehicle 100 of FIG. 1 or used in conjunction with some or all of the components thereof.

In the powertrain 300, wheels 316 are driven by the electric motor 322, either directly or through a gearbox (not shown). The electric motor 322 transforms electric energy stored in an electric battery 318 into mechanical energy to drive the wheels 316. The electric battery 318 can be a lightweight, compact, high-performance battery, such as a lithium-ion battery. The electric motor 322 obtains its power from the electric battery 318 via an inverter 320. The electric battery 318 stores electric energy and supplies the energy to the motor as needed. The inverter 320 is a bidirectional power converter that is configured to convert direct-current (DC) power to alternating-current (AC) and to convert AC power to DC power. The inverter 320 converts DC power stored in the electric battery 318 to AC power and supplies the resultant AC power to the electric motor 322, which then drives the wheels 316. During deceleration, AC power is generated by the electric motor 322 (which is configured as a motor-generator) through regenerative braking. The 320 inverter converts the AC power generated through regenerative braking into DC power and stores the DC power in the electric battery 318. can be captured and stored in the electric battery 318 via regenerative braking.

A control module 324 controls the operation of the vehicle. The control module 324 can be or include a processor, such as the processor 133 of FIG. 1. A powertrain control planner according to implementations of this disclosure, such as a planner 326, can be stored in a memory, such as the memory 134 of FIG. 1. Alternatively, the control module 324 can be implemented using specialized hardware or firmware. The control module 324 can execute the planner 326 in order to determine how to control the powertrain 300 of the vehicle 100. As an example, the planner 326 may be provided to the control module 324 in the form of executable instructions that, when executed, cause operation of the planner 326 as will be described herein.

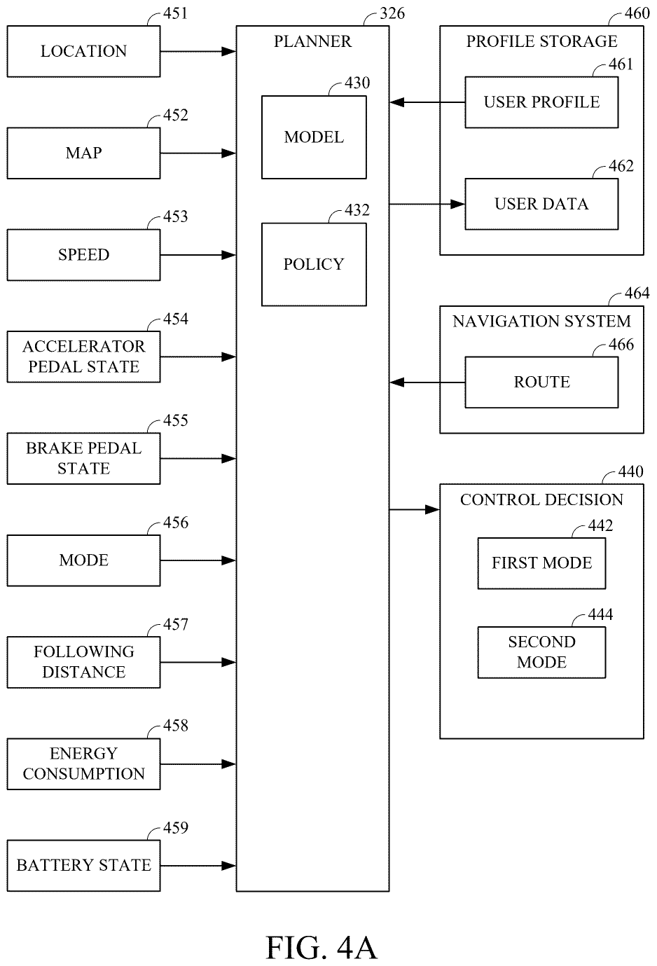

As shown in FIG. 4, which is a diagram of a planner that is implemented by the control module 324, the planner 326 includes a model 430 (e.g., a decision-making model) that is configured to generate a powertrain control policy, such as a policy 432. The policy 432 is a solution or group of solutions to the model 430 that indicates the next action to be taken for a given state. Using the model 430 and the policy 432, the planner 326 is configured to determine a powertrain control decision, such as a control decision 440, that can be used to operate the powertrain 300. The control decision 440 may be or include a changed accelerator input-output mapping or an eco mode activation or deactivation. The planner 326 is configured to determine the control decision 440 for each possible state that could arise. As a vehicle 100 operates, the plan can be further refined. That is, given a current position of the vehicle 100, the planner 326 can plan whether an accelerator input-output mapping should be changed and/or whether an eco mode activation status should be turned on or off. In an example, the powertrain control planner can use speed information from a navigation map.

The planner 326 utilizes multiple types of information regarding the current state of the vehicle 100 as inputs to the model 430. In the illustrated implementation, the inputs that are obtained (e.g., received, retrieved, generated, etc.) by the planner 326 include location information 451, a navigation map 452, a current speed 453 of the vehicle 100, an accelerator pedal state 454, a brake pedal state 455, an eco mode state 456, a following distance 457, energy consumption information 458, and a battery state 459.

Additional vehicle parameters may be used as inputs for the model 430 and can be or can include any relevant vehicle-specific information that can be used by the model 430 for determining the control decision 440. In an example, the vehicle parameters may be known a priori. In another example, the vehicle parameters can be learned. In an example, respective constants can be learned for at least some of the parameters by averaging each over time. Thus, values corresponding to at least some of the vehicle parameters can be collected from the vehicle 100 over time and then averaged. In an example, respective functions can be fit to at least some of the vehicle parameters.

The location information 451 represents the current location of the vehicle 100 relative to the vehicle transportation network 220. The location information 451 can be obtained by the planner 326 from the location unit 131 as previously described or can be determined based on information obtained from the location unit 131. As one example, the location information 451 may be expressed as a current position of the vehicle 100 in two or three dimensions and a current angular orientation of the vehicle 100. As another example, the location information 451 may be expressed relative to features of a navigation map, such as by identifying a segment (e.g., edge) or node of the navigation map at which the vehicle 100 is present.

The navigation map 452 includes geospatial information that is encoded in a computer-readable form and represents the features of the vehicle transportation network 220 in a manner that can be used by the model 430 as an input. The navigation map 452 can be defined as a directed graph [symbol] V, E [symbol] of vertices V and edges E. Each vertex v∈V can have the parameters latitude, longitude, and altitude, as shown in Table I. Each vertex v defines a coordinate in space as well as another parameter comprising a unique identifier (Id). The vertices can have fewer, more, other parameters, or a combination thereof.

TABLE I

| Parameter Name | Units | Parameter |
|---|---|---|
| Id | — | v_{id} |
| Latitude | Degrees | vₗₐₜ |
| Longitude | Degrees | vₗₒₙ |
| Altitude | M | vₐₗₜ |

Each edge e∈E can have the parameters listed in Table II. An edge e connects two vertices. As such, an edge e can have the parameters From Vertex ID (which identifies a first node), To Vertex ID (which identifies a second node), a unique ID, and semantic road traversal information usable by the eco mode activation planner. In an example, the semantic road traversal information useful for eco mode activation planning can include one or more of the following parameters. A parameter eₙₜₜ denotes the number of times that the edge has been traversed. A parameter eₐₜₛ denotes the average speed of all the traversals of the edge. A parameter eₐᵢₛ denotes the average initial speed of vehicles when entering the edge. A parameter e_{afs} denotes the average exit or final speed of vehicles when exiting the edge. A parameter e_{abcr} denotes the average battery consumption/regeneration, which refers to all non-stop driving along the edge. The average battery consumption/regeneration e_{abcr} automatically incorporates the consequences of slope of the edge, road type of the edge, and traffic on the edge by simply recording, on average, how much change in battery level there was after traversal. A vertex also independently models full stops, denoting how many times a stop occurred eₙₜₛ, the duration of the stop eₐₛₜ, and how the average battery level changes from regenerative braking e_{abrs}. The parameter eₑₘₐ captures if the eco mode was active along the edge.

TABLE II

| Name | Units | Parameter |
|---|---|---|
| ID | — | e_{id} |
| From Vertex ID | — | e_{from} |
| To Vertex ID | — | eₜₒ |
| Number of Times Traversed | — | eₙₜₜ |
| Number of Times Stopped | — | eₙₜₛ |
| Average Traversal Speed | km/h | eₐₜₛ |
| Average Initial Speed | km/h | eₐᵢₛ |
| Average Final Speed | km/h | e_{afs} |
| Average Traversal Time | H | eₐₜₜ |
| Average Stop Time | H | eₐₛₜ |
| Average Battery Consumption/Regeneration | kWh | e_{abcr} |
| Average Battery Regeneration on Stop | kWh | e_{abrs} |
| Eco mode activated | — | eₑₘₐ |

In an example, the navigation map 452 can be obtained, e.g., learned, acquired, purchased, leveraged, used, etc. The navigation map 452 may be purchased from a third party (e.g., an external source) that maintains such information. The navigation map 452 can be learned as a vehicle is traversing the roads. In an example, the navigation map 452 may be an obtained navigation map that is updated by driving history of the vehicle. The navigation map 452 may be available as a callable service (such as a cloud-based service), which the planner 326 can programmatically call to request the information from the navigation map 452 that the planner requires.

In some implementations, some of the parameters of the navigation map 452 may have different semantics than those described above. To illustrate, for example in the case of a purchased navigation map, the Number of Times Traversed may be given in the form of a probability. The probability can also be computed from, for example, the number of times traversed and a number of all outgoing edges.

The navigation map 452 can include learned historical driving patterns. The navigation map 452 can include learned final goal (e.g., destination) locations. The historical driving patterns can be those of a particular vehicle for which a powertrain control plan (e.g., the policy 432) is to be calculated, those of a particular driver of the particular vehicle, those of an aggregated learned historical driving pattern of several vehicles or several drivers, or a combination thereof.

In an example, the driving history can be captured, and the navigation history can be learned from GPS traces. A GPS trace can be defined as a vector \vec{g}= [symbol] g₁, . . . , g_{|\vec{g}|} [symbol] of GPS locations along a driving path of the vehicle. The set of all GPS traces is the set G. For each GPS trace, which is formed of discrete points, the discrete points \vec{g}ᵢ, \vec{g}ⱼ∈G are paired for each contiguous road segment length that is within a pre-defined tolerance dₜₒₗ>0 from one another. In an example, the pre-defined tolerance dₜₒₗ can be 100 meters. However, other lengths are possible. The average of the beginning points and the average of the end points in the segment of \vec{g}ᵢ and \vec{g}ⱼ form two vertices. An edge can then be added to the navigation map 452 that contains the parameters of the navigation map 452, such as those described above with respect to Table III. That is, an edge that is added to the navigation map 452 can average recorded speeds, battery consumption, etc. along the segments. Adding edges to the navigation map 452 can also include adding vertices corresponding to the edge.

It is noted that average battery consumption/regeneration can be stochastic based at least on (1) the branching statistical distribution of edge traversal times (further described below) of the navigation map 452, (2) multiple possible routes splitting and joining to reach the same goal, and (3) regenerative braking during stochastic stops in slow traffic and traffic lights. Thus, the battery level at any upcoming edge of the navigation map 452 can have an associated probability distribution. This stochastic process can be naturally modeled as a Markov chain; however, actions (such as turning on or off the eco mode) can affect the battery level. Thus, the model 430 can more accurately determine powertrain control decisions.

In an example, the navigation map 452 can include two parts. A first part can be fixed (e.g., purchased, static, unchangeable) and can include parameters such as Average Speed and the like. A second part can be a learned part and is necessary for determining an optimal powertrain control plan. The second part of the navigation map 452 can be unique to the vehicle 100 (or a particular driver of the vehicle) and includes information obtained during trips made by the vehicle 100 under control of all drivers or under the control of a particular driver. Using this information, the planner 326 can determine the control decision 440 without knowing the destination of the vehicle 100.

Where the destination of the vehicle 100 is known (such as when a driver enters a destination in a routing application), the control decisions 440 may be determined based on a known route to the destination using information from the navigation map 452 for the known route. When the destination is not known, then the planner 326 may consider possible routes within a threshold distance of the vehicle 100. The possible routes may be determined based on information from the navigation map 452, such as turn probabilities, and can also be determined based on information regarding previous destinations visited by the driver of the vehicle 100.

The current speed 453 of the vehicle 100 may be a scalar value expressed in a suitable form, such as meters per second or kilometers per hour. The current speed 453 may be obtained from a wheel speed sensor, from the location unit 131, or from any other suitable source.

The accelerator pedal state 454 is a value that represents a degree of operation of an accelerator pedal of the vehicle 100 and represents a driver demand for driving torque and/or acceleration of the vehicle 100. The accelerator pedal state 454 may be a value that ranges from a minimum that represents no operation of the accelerator pedal (e.g., no force applied by the driver) and a maximum that represents full operation of the accelerator pedal. The minimum and maximum values of the accelerator pedal state may be subject to dead zones. Operation of the accelerator pedal may be sensed by a suitable type of sensor. In one implementation, a position sensor is used to measure movement of the accelerator pedal away from the resting/no operation position, and the accelerator pedal state may be a function (e.g., a linear function between minimum and maximum) of the distance (e.g., an angular distance or a linear distance) by which the driver of the vehicle 100 has moved the accelerator pedal. In an alternative, a force sensor such as a load cell is used to measure the force applied to the accelerator pedal and the accelerator pedal state may be a function (e.g., linear between minimum and maximum) of the force applied by the driver.

The brake pedal state 455 is a value that represents a degree of operation of a brake pedal of the vehicle 100 and represents a driver request for deceleration. The brake pedal state 455 may be a value that ranges from a minimum that represents no operation of the brake pedal (e.g., no force applied by the driver) and a maximum that represents full operation of the brake pedal. The brake pedal state 455 may otherwise be implemented in the manner discussed with respect to the accelerator pedal state 454.

The eco mode state 456 indicates whether the eco mode is currently active or whether a different driving mode is currently active. The eco mode state 456 may be changed (e.g., between activation and non-activation of the eco mode) by the planner 326 via the control decision 440 or by a user input. The user input may be operation of an HMI feature such as a physical button or a control displayed on a touch-sensitive input device.

The following distance 457 is a value that represents a distance between the vehicle 100 and a preceding vehicle that is travelling directly ahead of the vehicle 100 on the vehicle transportation network 220. The following distance 457 may be obtained from a sensor, such as the on-vehicle sensor 209. Suitable sensing modalities can be used, such as radar, laser, LIDAR, etc.

The energy consumption information 458 describes energy consumption by the vehicle 100 inclusive of the powertrain 300 thereof, and may be expressed in any suitable manner, such as kilowatts. As an example, the energy consumption information 458 may describe current energy use of by the powertrain 300 of the vehicle 100 under the current states of the vehicle 100. The battery state 459 represents an amount of energy available in the electric battery 318 to power the electric motor 322 and other systems of the vehicle 100. The battery state 459 may be or include a battery level (e.g., in kWh), which can be in the range of 0 to a total battery capacity. The battery state 459 may also be expressed as a state of charge percentage.

To allow access to information about the user, a profile storage system 460 may be implemented locally at the vehicle 100, for example, using the processor 133 and the memory 134, or may be located remotely, for example, as a server-based system accessed using wireless communications as previously described. The profile storage system 460 is configured to store a user profile 461 that includes information about the driver of the vehicle 100, such as driver behavior information, which is useful in determining the model 430. The user profile 461 may contain information representing behavior of the driver during previous trips, and/or may contain information determined based on user data 462 transmitted to the profile storage system 460 during or subsequent to previous trips in the vehicle 100 or in other vehicles.

The planner 326 may make decisions based on part on information obtained from a navigation system 464 of the vehicle 100. The navigation system 464 may be configured to display a map to the user, such as the navigation map 452, and may be configured to allow the user to specify a location. Using the specified location, a routing algorithm may be used (either locally or at a remote service) to determine a planned route 466. The planned route 466 may identify portions of the navigation map to be used by the vehicle 100 for travel to the destination and may provide turn-by-turn directions to the user. Information such as the selected destination and the planned route 466 may be provided to the planner 326 and used to determine the control decision as will be described herein.

The control decision 440 may be or include determination of whether to select a first powertrain control mode 442 or a second powertrain control mode 444 for use by the vehicle 100 in controlling the electric motor 322. This decision is made based on the states of the vehicle 100 that are provided to the model 430 as inputs. The first powertrain control mode 442 prioritizes performance while the second powertrain control mode 444 prioritizes efficiency. Thus, the first powertrain control mode 442 provides higher performance from the electric motor 322 of the vehicle 100 as compared to the second powertrain control mode 444, and the second powertrain control mode 444 reduces discharge of the electric battery 318 as a result of operation of the electric motor 322 of the vehicle 100 as compared to the first powertrain control mode 442.

In one implementation, the first powertrain control mode 442 includes a first accelerator input-output mapping, and the second powertrain control mode 444 includes a second accelerator input-output mapping that differs from the first accelerator input-output mapping. The first accelerator input-output mapping and the second accelerator input-output mapping may be instructions to modify a mapping that relates the degree of operation of the accelerator pedal to the desired output torque of the electric motor 322 of the vehicle 100. The first accelerator input-output mapping and the second accelerator input-output mapping may be predetermined accelerator input-output mappings. The number of possible input output mappings is not limited to two, and additional mappings including continuously variable input output mappings may be used.

As an example, the first accelerator input-output mapping may prioritize efficiency over performance, may have a lower ratio of output torque of the electric motor relative to the degree of operation of the accelerator pedal as indicated by the accelerator pedal state 454 as compared to the second accelerator input-output mapping, and may have a lower maximum torque that is commanded by maximum operation of the accelerator pedal. Similarly, the second accelerator input-output mapping may prioritize performance over efficiency, may have a higher ratio of output torque of the electric motor relative to the degree of operation of the accelerator pedal as indicated by the accelerator pedal state 454 as compared to the first accelerator input-output mapping, and may have a higher maximum torque that is commanded by maximum operation of the accelerator pedal. Thus, for the same value of the accelerator pedal state 454, a lower torque of the electric motor 322 is commanded when the first accelerator input-output mapping is used as compared to when the second accelerator input-output mapping is used.

In one implementation, the first powertrain control mode 442 is a non-eco mode (e.g., eco mode is deactivated) and the second powertrain control mode is an eco mode (e.g., eco mode is activated). The eco mode may be an explicit, user-changeable setting (e.g., using a button or other HMI element) that changes the control of the electric motor 322 between a performance-oriented mode (the non-eco mode) and an efficiency-oriented mode (the eco mode). Thus, switching between the first powertrain control mode 442 and the second powertrain control mode 444 may include switching to a mode that prioritizes performance over efficiency or may include switching to a mode that prioritizes efficiency over performance. Activating or deactivating the eco mode by changing between the first powertrain control mode 442 and the second powertrain control mode 444 may include changing the accelerator input-output mapping and/or may include other changes to the mode of operation of the powertrain 300 of the vehicle 100. Thus, control decision 440 may be or include a decision to switch operation of the vehicle from another mode to eco mode, or to switch operation of the vehicle to another mode from eco mode. The eco mode and a different control mode may each include a separate input-output torque mapping such as the first accelerator input-output torque mapping and the second accelerator input-output torque mapping described above. Other changes to the operation of the powertrain 300 may also be made between the eco mode and a different control mode.

FIGS. 4B-4C are graphs that illustrate a first relationship 470 (FIG. 4B) and a second relationship 472 (FIG. 4C) between the accelerator pedal state 454 and a resulting motor output 474 (e.g., torque) of the electric motor 322 according to an example. The first relationship 470 may correspond to operation in the first powertrain control mode 442, and the second relationship 472 (FIG. 4C) may correspond to operation in the second powertrain control mode 444.

The first relationship 470 depicts a higher performance mode as compared to the second relationship 472, and may correspond, for example, to operation of the powertrain 300 when the eco mode is deactivated. The second relationship 472 depicts a lower performance mode as compared to the first relationship 470, and may correspond, for example, to operation of the powertrain 300 when the eco mode is activated. The x-axis denotes the magnitude of the accelerator pedal state 454, such as a distance, angle, or pressure by which the accelerator pedal (or other accelerator input) is activated by the driver. The y-axis indicates the resulting magnitude of the output of the electric motor 322, such as a torque output of the electric motor 322 which is related to acceleration of the vehicle 100 as a result of operation of the electric motor 322. The first relationship 470 shows that, in the first powertrain control mode 442, the motor output 474 increases more rapidly in response to operation of the accelerator as compared to equivalent operation of the accelerator in the second powertrain control mode 444, as seen in the second relationship 472. The higher level of the motor output 474 for the first powertrain control mode 442 as compared to the second powertrain control mode 444 for equivalent values of the accelerator pedal state 454 allows for higher performance operation in the first powertrain control mode 442 and allows for higher efficiency operation in the second powertrain control mode 444 in response to equivalent driver operation of the accelerator.

With further reference to FIG. 4A, the control module 324 operates the vehicle 100 according to the control decision 440. In an example, the control module 324 may directly communicate with (e.g., transmit signals or commands to, etc.) the electric motor 322 to change the accelerator input-output mapping and/or to activate (e.g., turn on or off) the eco mode according to the control decision 440. In an example, the control module 324 may transmit the control decision 440 to an electric motor control module (not shown) that implements the control decision 440 by changing the accelerator input-output mapping and/or by activating the eco mode.

Powertrain control planning, as implemented by the planner 326, can be performed using the model 430, which is configured to make a decision through an optimization process that considers two or more conflicting objectives. The conflicting objectives include performance and energy efficiency in the system described herein and may include other objectives. In the implementation that is described herein, powertrain control planning is modeled as a multi-objective Markov decision process (MOMDP) problem, which is a type of Markov decision process (MDP) problem. MOMDP is a framework for sequential decision-making in environments in which multiple, often conflicting objectives must be optimized simultaneously. It extends the MDP by considering vector-valued rewards, where each component of the reward vector corresponds to a different objective. Thus, instead of optimizing a single scalar reward, an MOMDP is intended to optimize a set of objectives.

The decision model can be formally modeled as a tuple [symbol] S, A, T, C [symbol] . The variable S (e.g., S^{T}×S^{B}×S^{M}) can be a finite set of state (e.g., S^{T}—current road, S^{B}—battery level, S^{M}—accelerator input-output mapping or eco mode status). The variable A can be a finite set of actions (e.g., use first accelerator input-output mapping, use second accelerator input-output mapping, eco mode on, eco mode off). The variable T (e.g., T(s, a, s″)) can be a state transition function that represents the probability that successor state s′∈S occurs after performing an action a∈A in a state s∈S. The variable C(s, a) can represent a cost function that represents the expected immediate cost(s) of performing an action a∈A in a state s∈S. Additionally, there can be multiple distinct cost functions (e.g., multi-dimensional cost vector). The multiple distinct cost functions may consider objectives including, but not limited to performance, energy efficiency, safety, stability, and travel time. Other objectives may be modeled by the cost functions.

A solution to the model can be a policy π:S→A (e.g., the policy 432). That is, under the policy π, an action a (e.g., π(s)) is selected for a state s. That is, the policy π can indicate that the action π(s)∈A should be taken in state s. The policy π can include a value function V^{π}:S→C that can represent the expected cumulative cost V^{π}(s) of reaching a goal state, from a state s following the policy π. That is, the value function can provide an expected cost (e.g., a value) for each intermediate state, from the start state until a goal state is reached. An optimal policy π* minimizes the expected cumulative cost.

To achieve a balance between different control strategies, the decision model may employ multiple scalarization functions, e.g., within an MOMDP. Different scalarization functions translate the multi-dimensional cost vector into a single cost value, thereby accommodating varying optimization priorities. For example, a linear weighted sum function could prioritize a balance between energy efficiency and travel time, while a Chebyshev scalarization function might focus on minimizing deviations from ideal targets across all objectives. By using a range of scalarization functions, the system can generate a set of Pareto-optimal policies, each exhibiting a distinct behavior (e.g., minimize energy use, maximize performance, optimize energy and performance, etc.) tailored to the user's preferences or changing environmental conditions. The scalarization function can be used to convert the model/problem into a shortest path optimization problem (SSP). That is, a single value indicating the long-term utility of a next immediate action can be obtained using the scalarization function, which combines the expected costs to obtain the single value.

For example, an assumption may be made that at least two objectives are possible: a first objective to minimize battery consumption and a second objective to minimize wasted energy. Wasted energy can result, for example, when the battery is at a certain capacity (e.g., 100%) and can't be charged further by available energy from regenerative braking. Thus, the available energy is wasted energy. Depending on which of the objectives is selected (such as by default or by the driver) as the more important or primary goal, different weights can be assigned to each of the first and second costs associated with the objectives. In an example, the scalarization function can be a weighting the total energy plus a very small constant factor for battery consumption and wasted energy and for toggling of the eco mode. Examples of objectives and costs are further described below.

In another example, constrained optimization can be used where a respective budget (e.g., a range, a maximum, a minimum) can be set for each of the costs and where the costs can be ranked in terms of importance. For example, a single objective (e.g., minimize battery consumption or minimize travel time) can be set as a primary objective to be optimized. A model (such as an MOMDP) can consider each objective in a particular order. The model can constrain the available actions and/or policies for subsequent objectives following the particular order. For example, for a first objective, a set of actions A(s) can be kept (e.g., maintained, etc.) for each state s. Only the actions that satisfy a value criteria can be kept in the action set A(s) for each state. The second objective in the ordering can then solve its objective while being constrained to the available actions/policies that the first objective limited its access to. This process repeats until all objectives have been examined.

The constituents of the tuple [symbol] S, A, T, C [symbol] of a model, particularly an MOMDP in this example, can now be further described.

The state space can be defined as S=S^{T}×S^{B}×S^{M}. In this equation, S^{T}=E, the set of edges in the navigation map. As such, S^{T} can be the set of roads (or more accurately, road segments) in a navigation map, which is further described below. The set of roads S^{T} can be the set of roads that the vehicle has historically driven. Further, S^{B}⊂[0, θ_{bc}] is the current battery level (in kWh), which can be in the range of 0 to the total battery capacity θ_{bc} kWh. The current battery level can be discretized at a regular interval/resolution. For example, given a discretization resolution of 30, the current battery capacity can be one of the values of the set

$${S}^{B} = \{ \frac{0}{30} {\overline{θ}}_{bc} , \frac{1}{30} {\overline{θ}}_{bc} , … , \frac{30}{30} {\overline{θ}}_{bc} \} .$$

Finally, S^{M} represents the current operating mode. In one example, the current operating mode of the vehicle 100 may be represented by the first powertrain control mode 442 and the second powertrain control mode 444, which may each be an accelerator input-output mapping such as a ratio, a curve, a maximum value, a formula, a value that identifies a particular mapping, or another representation. In another example, the current operating mode of the vehicle 100 can represent whether the eco mode is active such that S^{M}={off, on} corresponding to deactivated and activated states of the eco mode, respectively.

Other factors can be considered/included in the state space. For example, one or more parameters of the navigation map can be included/considered in the state space. For example, the rate of battery discharge (e.g., a current rate of discharge), the degree of traffic (e.g., a congestion level), and/or other factors can be part of the state space S. In an example, the degree of traffic may be an ordinal variable having values such as (“light”, “average”, “heavy”). For example, factors related to the rate of battery discharge and/or the current power usage, such as whether an entertainment system, e.g., a radio, of the vehicle is on/off and/or whether the air conditioner/heater of the vehicle is on/off, can be considered in the state space. Furthermore, the powertrain control decisions can be based on the current power usage of the vehicle.

The action space A is the set of control decisions, such as control decision 440, which may include selection of the first powertrain control mode 442 or the second powertrain control mode 444. The MOMDP selects one of the powertrain control modes (e.g., a value for the accelerator input-output mapping or a decision of whether to turn the eco mode on or off) for a next edge of the navigation map to be traversed immediately following the current edge. Thus, in an example, the action space may be A={mapping}, A={ratio}, or A={off, on}. If the eco mode is currently in a state S^{M}∈S^{M}. and the next powertrain control decision sets the eco mode to the same state, then no action may be performed on the electric motor 322. That is, the current state does not change.

In some implementations, the action space A can include other actions related to other power-consuming components of the vehicle. For example, an action selected by the planner may be to lower the air conditioner of the vehicle to reduce the amount of battery power consumption.

The transition function T can include capturing the movement in (e.g., according to, etc.) the edges of the navigation map, the change in battery level, and the change in eco mode based on the navigation map and the powertrain control decision that was performed.

With respect to the costs C, several cost functions can be considered. In an implementation, the cost functions include a performance cost function C_{perf}, an efficiency cost function C_{eco}, a safety cost function C_{safe}, and a stability cost function C_{stable}. Different cost functions or additional cost functions may be used. The costs computed from the individual cost functions are combined to determine a total cost. This combination may be a sum, a weighted sum, or another type of combination. Other costs are also possible. While the objective of the model (in this example the MOMDP) is to minimize the expected costs over time, the cost functions are the costs associated with a next immediate one-step cost of the next powertrain control decision.

The performance cost function C_{perf} results in a high cost for operation in an efficiency-focused mode when there is a demand for high performance (e.g., high speed and/or acceleration). In an implementation, C_{perf} is determined based on a maximum speed, the user profile 461, the current speed 453, the accelerator pedal state 454, and a slope. The maximum speed is the highest speed at which the vehicle 100 can travel the next portion of the route and may be determined based on the navigation map 452 and/or based on other information. As an example, the maximum speed may be set equal to the speed limit for the next portion of the route. The user profile 461 is used to provide information about the driver's preferences in order to modify the maximum speed to allow operation at a speed that is comfortable for the driver. The current speed 453 and the accelerator pedal state 454 are as previously described and are used to provide information about acceleration demand. The slope may be a measure of the road grade to account for differing performance demands for travelling uphill or downhill and may be determined based on the navigation map 452.

A target speed for the vehicle may be determined based on the maximum speed and the user profile, such as by multiplying the maximum speed by a factor obtained from or derived from the user profile, from a lookup table based on the maximum speed and information from the user profile, or from a function that utilizes the maximum speed and information from the user profile as inputs. As will be described further herein, information from the navigation map 452 may be used to determine the target speed. The safety cost function C_{perf} is then evaluated based on the current speed 453, the target speed, the accelerator pedal state 454, the slope, and weighting factors. In an implementation, C_{perf} is equal to (Mode*((DeltaSpeed*K_{acc}*AccelPedal)+(Kₛᵢₚ*Slope)), where Mode represents the current operating mode of the vehicle 100, DeltaSpeed is a difference between the current speed 453 and the target speed, K_{acc} is a weighting factor the adjusts the influence of acceleration demand, AccelPedal represents the acceleration demand and may be the accelerator pedal state 454 or a value determined based on it, Kₛₗₚ is a weighting factor that adjusts the influence of road grade, and Slope is a value that represents the road grade. In some implementations, Mode is equal to zero when eco mode is deactivated and is equal to one when eco mode is activated, implying that no performance-related cost is imposed when the maximum amount of performance is available via deactivation of eco mode. In some implementations, Mode is a value that represents the current powertrain control mode of the vehicle 100, such as the first powertrain control mode 442 or the second powertrain control mode 444. As an example, the value of Mode may be between zero and one, inclusive, with zero representing a most performance-focused setting for control of the powertrain 300 with one representing a most efficiency-focused setting for control of the powertrain 300. Thus, a highest cost is imposed by C_{perf} when the vehicle 100 is operating according to its most efficient mode (e.g., eco mode), and the lowest cost (e.g., zero) is imposed by C_{perf} when the vehicle 100 is operating according to its highest performance mode.

The efficiency cost function C_{eco} results in a high cost for operation in a performance-focused mode, based on the current energy consumption and the battery level. In an implementation, c_{eco} is determined based on the battery state 459 and the energy consumption information 458. Other information may be used. For example, information from the user profile 461 may be used to apply an increase to the efficiency cost based on a user preference to prioritize efficiency over performance.

The energy consumption information 458 may be measured or estimated by the control module 324. To estimate the energy consumption information, the control module information may utilize information from vehicle systems including acceleration, the current speed 453, the target speed (described above), the powertrain control mode, and/or other information. This information may be provided to an estimation function or to a trained machine learning model to estimate the energy consumption. In an implementation, C_{eco} is equal to Mode*EnergyConsumption*(K_{batt}*BatteryLevel). In this calculation, Mode represents the current operating mode of the vehicle 100 as explained with respect to C_{perf}, EnergyConsumption is a value that represents the amount of energy used by the electric motor 322 and is based on the energy consumption information 458, K_{batt} is a weighting factor the adjusts the influence of the battery state 459, and BatteryLevel represents the battery state 459.

The safety cost function, C_{safe}, is designed to ensures that changes to the performance available from the electric motor 322 do not compromise safety by selectively suppressing transition from a higher performance mode to a lower performance mode. This may be achieved by assigning a high cost to transitioning from a higher performance mode (e.g., eco mode off) to a lower performance mode (e.g., eco mode off) under conditions that may compromise safety. C_{safe} may be determined based on operating states of the vehicle 100, based on the locations of other vehicles relative to the vehicle 100, and optionally based on other factors.

In an implementation, C_{safe} is determined based on the brake pedal state 455, the current speed 453, and the following distance 457. The powertrain control mode of the vehicle 100 is also considered, such that the cost for an action that switches to the eco-off mode or otherwise reduces performance is higher that the cost for an action that results in a higher performance for the electric motor 322 of the vehicle 100. In an implementation, the safety cost function C_{safe} is equal to Mode*((K_{brk}*BrakePedal)+EnvironmentChec(CurrentSpeed,FollowingDistance)). In this calculation, Mode represents the current operating mode of the vehicle 100 as explained with respect to C_{perf}, and may vary between zero and one, where zero represents operation of the vehicle in a highest performance mode and where one represents operation of the vehicle in a lowest performance mode. The brake pedal state 455 is represented by BrakePedal, and its degree of influence is determined by a weighting factor K_{brk}. A function named EnvironmentCheck is dependent on the current speed 453 of the vehicle 100 and the following distance 457 of the vehicle 100 relative to a preceding vehicle. The value of EnvironmentCheck will be higher when other vehicles are close and/or when speeds are high, and lower when other vehicles are farther away and/or speeds are lower. EnvironmentCheck may be determined using a formula, a lookup table, a trained machine learning model, or another method that utilizes current speed 453 of the vehicle 100 and the following distance 457 of the vehicle 100 as inputs. Other inputs could also be used.

A stability cost C_{stable} is intended to reduce the occurrence of frequent mode switching. The stability cost C_{stable} may be determined based on the elapsed time since the last mode switch. The stability cost C_{stable} increases as the elapsed time since the last mode switch increases. In an implementation, C_{stable} is equal to 1/(min(Kₜ, TimeElapsed)), where min indicates that the smaller of Kₜ and TimeElapsed is selected, Kₜ is a default value used when the value of TimeElapsed is large, and TimeElapsed represents the amount of time that has passed since the last mode change, and can be calculated by subtracting the time value corresponding to the last mode change from the current time value.

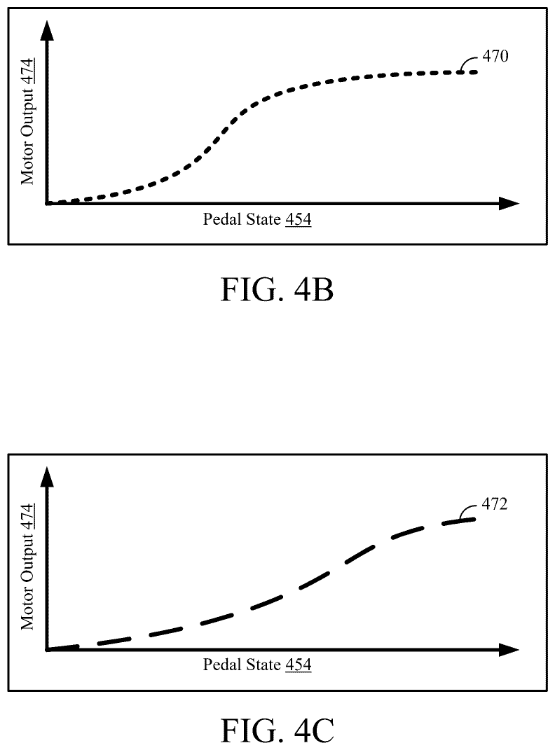

FIG. 5 illustrates a flow 500 of powertrain control planning according to implementations of this disclosure. The vehicle 100 (e.g., a BEV) may start a trip at block 502. As described previously, the destination may or may not be known. The planner 326 (e.g., a powertrain control planner) is initiated at block 504. The planner 326 uses the policy 432 to select (e.g., plan, predict, etc.), for each next road segment, the control decision 440, which may include selection of the first powertrain control mode 442 or the second powertrain control mode 444 for operation of the powertrain 300 of the vehicle 100.

The policy 432 may be determined (e.g., computed, calculated, etc.) online or offline. In the online case, the policy 432 is computed dynamically and can reflect/incorporate changes that are occurring in real or near real time as the vehicle 100 traverses edges of a navigation map, which is described above. In another example, the policy 432 may be calculated offline and used online (e.g., during actual drives of the vehicle 100). When computed offline, the policy 432 is computed once (e.g., prior to a drive), whereas an online-computed policy can be continually recomputed as the vehicle 100 is being driven. To compute the policy 432, as described above, vehicle parameters and the navigation map 452 are used. In the online case, the vehicle parameters and the navigation map 452 may be static. The vehicle parameters may include the inputs to the planner 326 that were described with respect to FIG. 3.

For an upcoming road segment, the planner 326 determines the control decision 440 (e.g., selection of the first powertrain control mode 442 or the second powertrain control mode 444) for that segment of the road. The planner 326, which may be executing in the vehicle 100, determines the control decision as described above with respect to the MOMDP. The expected speed of the vehicle on the next upcoming road segment and, optionally, additional upcoming road segments can be considered by the planner 326, for example, as an input to one or more of the cost functions used by the MOMDP. The planner can start to perform its algorithm as soon as the vehicle 100 is turned on. The BEV considers the possibilities (e.g., probabilities) of where the BEV (e.g., the driver of the BEV) may be going in the case that a route is not already known.

At block 506, after the vehicle 100 drives a road segment having a certain length, the planner may optionally record, at block 508, data related to at least some vehicle parameters, such as those described above with respect to FIG. 3. The data related to the vehicle parameters may be changed (e.g., updated, replaced, added to) by the new data. For example, the planner 326 may record the current speed 453 of the vehicle 100 as it traversed the road segment. The planner 326 may also record road data related to the segment (e.g., one or more edges) of the road that the vehicle is currently traversing. The road data related to the segment can be or can include at least some of the parameters described with respect to Table II.

If the trip ends, then the flow 500 proceeds to 510. Otherwise, the flow 500 returns to 504 to plan the next control decision. In an example, the flow 500 ends at block 510. In another example, the recorded data at block 510 (if any) may be transferred, such as to a central location (e.g., a cloud-based server). At the central location, the recorded vehicle parameters can be incorporated into a vehicle database 512 and the road data can be incorporated into a trip database 518. The respective data in the vehicle database 512 and the trip database 518 can be aggregated (e.g., averaged, statistically analyzed, etc.) by a vehicle model learner 514 and a navigation map learner 520, respectively. To illustrate, and without limitation, the navigation map learner 520 may determine, for a same road segment that is traversed multiple times, the average traversal speed eₐₜₛ, the average initial speed eₐᵢₛ, and/or the average traversal speed e_{afs}. Speeds may also be learned and incorporated in the navigation map 452 for specification locations along the road segment. In another example, the navigation map learner 520 may determine points (vertices) at which edges of the navigation map 452 should be inserted, which may correspond, for example, to locations where the BEV stopped, such as at a traffic light or a stop sign.

The navigation map learner 520 updates the navigation map 452, which can be or can include parameters such as those described with respect to Table I and Table II. The vehicle model learner 514 updates the vehicle parameters 516. The updated version of the navigation map 452 and/or the updated vehicle parameters 516, or portions thereof, can then be provided to the vehicle 100 so that the updated information can be used in a next trip. The particular time the vehicle 100 receives the updates is not critical—the vehicle 100 can receive the updates before the next trip, at the start of the next trip, periodically, etc. In one example, the navigation map 452 may include (e.g., incorporate) information received from many vehicles and many other trips on many other roads than those received from one vehicle trip and/or the updated vehicle parameters 516. In another example, the vehicle model learner 514 and/or the navigation map learner 520 can be available (e.g., can execute in, etc.) on the vehicle 100 itself. In such a case, vehicle model learner 514 and/or the navigation map learner 520 only learn the patterns of one or more of the drivers of the vehicle 100 itself.

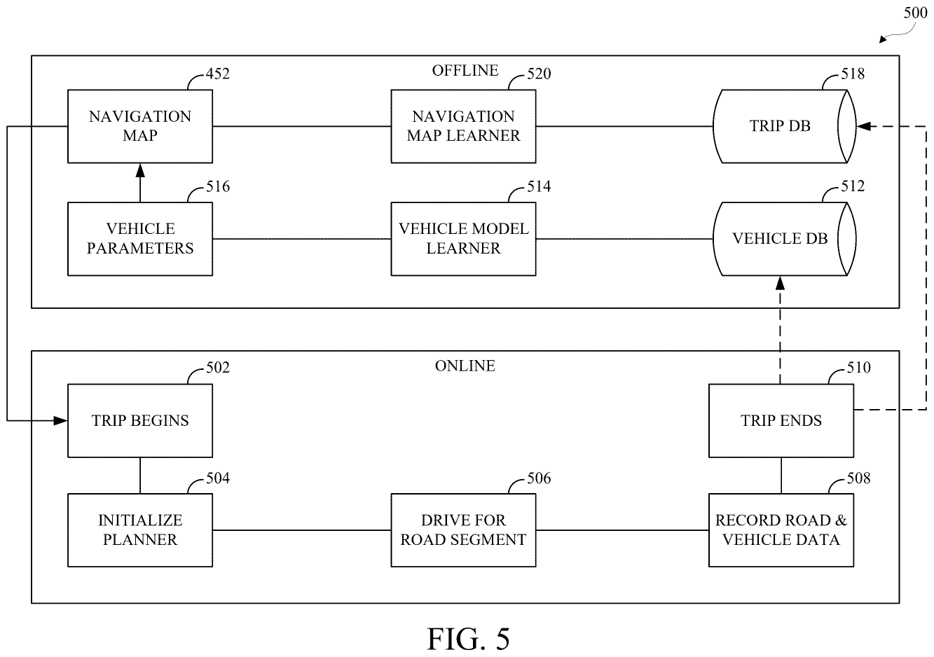

FIG. 6 illustrates an example 600 of travel by the vehicle 100 on a transportation network using information from the navigation map 452 according to implementations of this disclosure. The example 600 includes control mode changes that occur during travel by the vehicle 100, and the control mode changes may be recorded as described with respect to the flow 500. As an example, the control mode changes may be incorporated in the navigation map 452 and represented therein as edge parameters as described previously. The recorded data can be captured by the planner 326 and/or another powertrain control planner, which may be executing in the vehicle 100 or externally with respect to the vehicle 100.

The example 600 shows travel between a start point 602 and a destination point 604. The planner 326 records and stores the control mode used during travel between the start point and the destination point, such as whether the first powertrain control mode 442 or the second powertrain control mode 444 were used for specific portions of the travel route. During travel between the start point 602 and the destination point 604, the control mode may be changed (e.g., between the first powertrain control mode 442 and the second powertrain control mode 444) by the driver using an HMI element, or the control mode may be changed automatically by the planner 326 via the control decision 440.

In the illustrated implementation, the second powertrain control mode 444 is used for a first segment 606a, the first powertrain control mode 442 is used for a second segment 606b that follows the first segment 606a, and the second powertrain control mode 444 is used for a third segment 606c that follows the second segment 606b. These control mode changes may be performed automatically by the planner 326. As an example, the planner 326 may output the control decision 440 direction a change from the second powertrain control mode 444 to the first powertrain control mode 442 for travel within the second segment 606b due to a travel condition in the second segment 606b, such as a significant uphill road grade for which additional performance is helpful. The control decisions 440 and corresponding mode changes may be stored in the navigation map 452 as previously described for use in determining mode changes during future travel in the same location. The speed of the vehicle 100 at various points during travel along the first segment 606a, the second segment 606b, and the third segment 606c for use in determining mode changes during future travel in the same location.

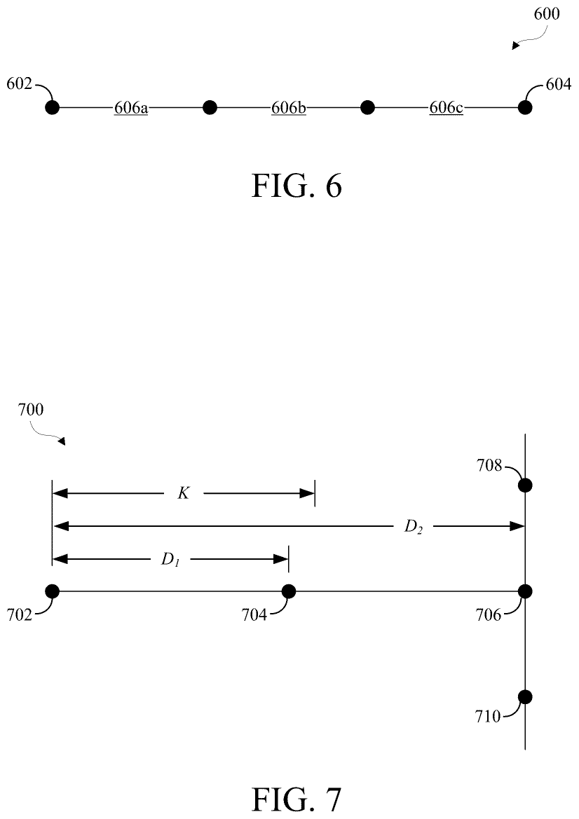

FIG. 7 is an illustration showing an example 700 of determination of the target speed for the vehicle 100 using the navigation map 452. This determination may be performed by the planner 326, which is configured to use the target speed for the vehicle 100 to determine the control decision 440. As an example, the model 430 may use the target speed as an input to determine the policy 432, such as by including the target speed as an input factor in a cost function, such as the performance cost function C-perf. To allow use of the navigation map 452 in determining the target speed for the vehicle 100, the navigation map 452 includes speed information at multiple locations of the transportation network that is represented by the navigation map 452. This speed information may be information obtained during previous drives by the current driver at the locations, may be information obtained during previous drives by one or more other drivers at the locations, or may be a combination thereof.

Initially, the location information 451, which represents the location of the vehicle 100 with respect to the vehicle transportation network 220, is utilized to determine the relevant portion of the navigation map 452. In the illustrated implementation, the current location of the vehicle 100 relative to the navigation map 452 is represented by a starting node 702, and a current travel direction of the vehicle 100 is known based on multiple samples of the location information 451 or based on information from another vehicle system.

In one example, the route that the vehicle 100 is following is known. The route that the vehicle 100 is following may be the planned route 466, which is obtained from the navigation system 464 of the vehicle 100. It should be understood that the planned route 466 may be considered the route that the vehicle 100 is following based on the expectation that the driver will follow the planned route 466, despite the fact that the driver could later choose to deviate from the planned route 466. In this example, the planner 326 identifies one or more locations along the planned route 466 and obtains information from the navigation map 452 for those locations. The planner 326 may obtain information for all such nodes that are located along the planned route 466 within a threshold distance from the current location of the vehicle 100. This distance may be referred to herein as a speed planning threshold. In the illustrated implementation, the locations with respect to which information is obtained are represented by nodes (e.g., discrete location), such as a stop node 704 (e.g., representing a location at which the vehicle 100 is required to stop), a branch node 706 (e.g., representing an intersection, and intermediate nodes 708, 710 (e.g., a points along a roadway). It should be noted that the locations considered by the planner 326 when determining target speeds could be any discrete location (e.g., a point speed) or any portion of a roadway (e.g., average speed along a road portion, edge, etc.).

In another example, the route that the vehicle 100 is following is not explicitly known. In that case, the route may be a predicted route that is determined based on the navigation map 452. The predicted route may be modeled in part as a set of probabilities that each correspond to whether the vehicle 100 will traverse a particular location (e.g., an edge or a node of the navigation map). To determine the probabilities of traversing particular locations, data indicating turning percentages (e.g., 30% chance of a left turn and 70% chance of a right turn), may be determined based on information incorporated in the navigation map 452, and this information may be based on previous behaviors by the current driver of the vehicle 100 (e.g., the turn percentages at this location for the current driver), previous behaviors by other drivers (e.g., the turn percentages at this location for other drivers), or a combination thereof. In this implementation, the planner 326 obtains information for all locations (e.g., nodes) that are reachable by the vehicle 100 within the threshold distance. Some of these locations represent mutually exclusive navigation decisions, such as a first branch node associated with turning left and a second branch node associated with turning right. In the illustrated example, it is expected that the vehicle will only reach one of the intermediate nodes 708, 710, and the probabilities of reaching them may be set at 30 percent and 708 percent, respectively, based on information from the navigation map.

Each location identified by the planner 326 within the threshold distance can be represented by several data values. As examples, the data values may include a node type, an expected speed (e.g., a target speed at the respective location), a distance, and a probability.

The node type is a value that indicates the type of location (e.g., stop sign, branch, or intermediate node). The node type may be used to control certain aspects of the target speed calculation. As an example, when a stop node, such as the stop node 704, is located along the route of the vehicle 100, the influence of subsequent nodes on the target speed may be ignored since the vehicle 100 is expected to come to a stop at the stop node.

The expected speed represents the target speed at that specific location (e.g., node). The distance is the measured distance from the vehicle's current position to the location. The probability (e.g., expressed as a value between zero and one, inclusive), is the likelihood that the vehicle will actually traverse the node during the drive as part of its route. When the route of the vehicle is known from the planned route 466, the probability for each of the nodes may be set equal to 1 (e.g., a one-hundred percent chance of traversal). The information describing the upcoming locations may be described in a suitable data structure, such as an array.

Using the expected speed information for the locations along the route as retrieved from the navigation map 452, the planner 326 is configured to calculate the target speed. As one example, the target speed may be calculated as a weighted combination (e.g., a weighted average or weighted sum) of the expected speeds for the locations along the route. Weighting may be based in part on the distance from the vehicle 100 to the respective location (e.g., one of the stop node 704, the branch node 706, or the intermediate node 708), where locations closer to the vehicle are weighted higher and therefore have more influence on the target speed. Weighting may be based in part on the probability that the vehicle 100 will traverse the respective location, ensuring that nodes with higher likelihoods of traversal have a greater impact on the calculation of the target speed. Weighting may be based on other factors.

The planner 326 may be configured to determine the target speed according to a formula that calculates the target speed based on the current speed of the vehicle 100 and the expected speed values for upcoming locations along the route that the vehicle 100 is travelling on. In an implementation, the target speed may be calculated according to the formula Vₜ=Vₛ+Σ(dVₙ*Rₙ*Pₙ), in which Vₜ is the target speed for the vehicle 100, Vₛ is the current speed of the vehicle 100, dVₙ is the difference between the speed for a location and a speed of the previous location (e.g., the previous node), Rₙ is a weighting factor based on a distance Dₙ of the location from the vehicle 100, and Pₙ is a weighting factor based on the probability that the vehicle 100 will traverse the location. As an example, the weighting factor Rₙ may be equal to 1 when the distance Dₙ between the vehicle 100 and the location is less than a threshold distance K (e.g., a full-weighting threshold distance), and Rₙ may be equal to the threshold distance K divided by the distance Dₙ of the location from the vehicle 100 when the distance Dₙ is greater than the threshold distance K. In the illustrated implementation, a distance D₁ to the stop node 704 is less than K and the weighting factor Rₙ for the stop node 704 will be equal to 1, while the weighting factor Rₙ for the branch node 706 will be equal to K/D₂, because the distance D₂ is greater than the threshold distance K. Other formulas or methods may be used to determine the target speed based on the current speed of the vehicle 100 and the expected speed values for upcoming locations along the route that the vehicle 100 is travelling on.

Upon determination of the target speed for the vehicle 100, the planner 326 utilizes the target speed for vehicle 100 to determine the control decision 440. Determination of the target speed and the control decision 440 may occur repeatedly. In one implementation, determination of the target speed and determination of the control decision 440 is performed multiple times per second. In another implementation, determination of the target speed and determination of the control decision 440 occur according to different frequencies. For example, determination of the control decision 440 may occur at a higher frequency than determination of the control decision 440.

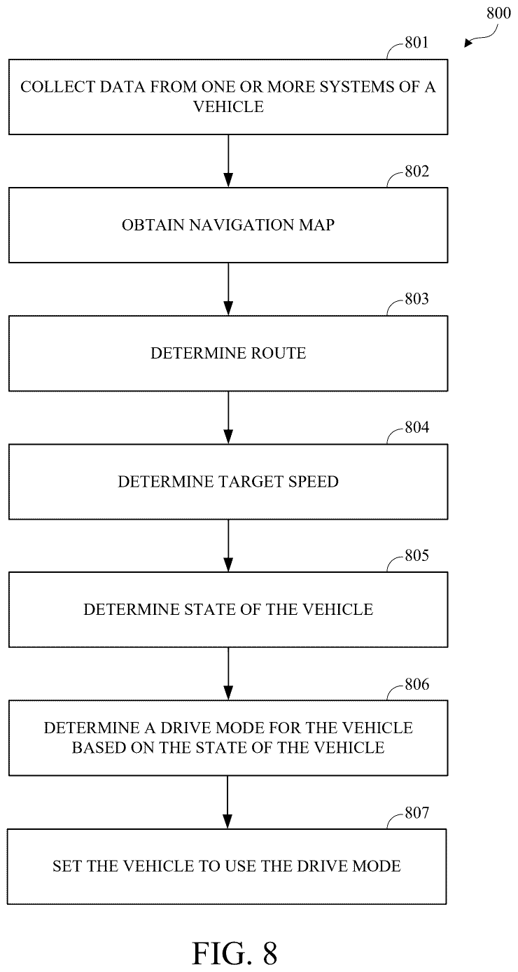

FIG. 8 a diagram of an example of a process 800 for determination of a powertrain control decision, such as the control decision 440, in accordance with an embodiment of this disclosure. The process 800 can be implemented, partially or fully, by a BEV, such as the vehicle 100 equipped with the powertrain 300. The process 800 can be implemented in a manually controlled vehicle, an autonomous vehicle (AV), a semi-autonomous vehicle, or in vehicles that include other types of drive-assist capabilities, including remote control of the vehicle. The process 800 can be implemented as instructions that are stored in a memory, such as the memory 134 of FIG. 1. The instructions can be executed by a processor, such as the processor 133 of FIG. 1. The process 800 may be performed in whole or in part by hardware.

Operation 801 of the process 800 includes collecting data from one or more systems of the vehicle 100. As previously described, the vehicle 100 is a BEV that includes the electric battery 318. As examples, the data collected from the one or more systems of the vehicle 100 may be or include the location information 451, the current speed 453, the accelerator pedal state 454, the brake pedal state 455, the eco mode state 456, the following distance 457, the energy consumption information 458, the battery state 459, the user profile 461, and/or the planned route 466.

As examples, the collected data could include navigation information (with potentially aggregated driver data for traffic predictions), a current state-of-charge of the battery, and a current discharge rate (e.g., current rate of discharge) of the battery. The data may be collected by the planner 326. The vehicle systems may include but are not limited to a navigation system, a communication system, or a system that monitors operator or driver behavior. In some implementations, the planner 326 may collect data about external factors such as traffic patterns (e.g., traffic data), proximity to other vehicles (e.g., proximity data), and weather data (e.g., weather conditions). For example, consider an example in which the vehicle 100 is preparing for a morning commute in a suburban area. The planner 326 begins by collecting relevant data. The navigation system 464 provides the planned route 466 and may incorporate aggregated driver/operator data to predict traffic congestion along the way. Simultaneously, the planner 326 queries the battery management system of the BEV for the current state-of-charge (e.g., 75%) and the current discharge rate (e.g., current rate of discharge). Optionally, an external communication system (e.g., smartphone of a driver) might provide weather data (e.g., clear skies expected) and real-time updates on traffic flow. Additionally, a driver behavior monitoring system may offer insights into the acceleration preferences of the driver (e.g., a preference for moderate acceleration).

Operation 802 of the process 800 includes obtaining the navigation map 452, which represents a vehicle transportation network, such as the vehicle transportation network 220, in a computer-interpretable form.

Operation 803 includes determining a route for the vehicle 100. In one implementation, the route for the vehicle 100 is a planned route that is obtained from a navigation system of the vehicle, such as the planned route 466 that is obtained from the navigation system 464. In another implementation the route for the vehicle 100 is a predicted route that is determined based on the navigation map 452, for example, using information regarding turning behaviors or historical roadway traffic volumes from the navigation map 452.

Operation 804 includes determining a target speed for travel of the vehicle along the route based on the navigation map 452. The target speed for travel of the vehicle along the route is determined according to speed information for locations along the route, as described with respect to FIG. 7. As an example, determined the target speed in operation 804 may include identifying one or more locations along the route, identifying expected speed information for the one or more locations along the route, and calculating the target speed based on the expected speed information for the one or more locations along the route. In some implementations, determining the target speed for the vehicle 100 in operation 804 further includes determining traversal probabilities indicating a likelihood that the vehicle will traverse each of the one or more locations along the route, wherein calculating the target speed is further based on the traversal probabilities for the one or more locations along the route.

Operation 805 includes determining a state of the vehicle, wherein the state of the vehicle comprises the target speed determined in operation 805. The vehicle state may further include other vehicle information, such as any or all of the information described with respect to collecting information from vehicle systems in operation 801.

Operation 806 includes determining, using a decision-making model, whether to use a first powertrain control mode or a second powertrain control mode based on the state of the vehicle, wherein the second powertrain control mode reduces a rate of discharge of the battery as compared to the first powertrain control mode. The decision-making model used in operation 806 may be the model 430, which may be implemented as an MOMDP, as described previously. The target speed determined in operation 805 may be used, for example, as an input to a cost function utilized by the model 430, such as the performance cost function C-perf, as previously described. Thus, the model 430 may account for how the target speeds at locations ahead of the vehicle 100 impact the decision to use a particular control mode. The determination of which powertrain control mode to use may be performed by the model 430 according to the policy 432, which is a solution or set of solutions generated by the model 430, as previously described. The powertrain control modes that are available for selection in operation 806 may be the first powertrain control mode 442 and the second powertrain control mode 444 as previously described. Additional powertrain control modes may be available for selection and use.

In operation 806, the first powertrain control mode 442 may include a first accelerator input-output mapping, and the second powertrain control mode may include a second accelerator input-output mapping that differs from the first accelerator input-output mapping. In operation 806, the decision-making model may be configured to determine whether to use the first powertrain control mode 442 or the second powertrain control mode 444 based in part on the performance cost function C-perf, which utilizes a difference between the target speed and a current speed of the vehicle 100 as an input.

Operation 807 includes setting the vehicle 100 to use one of the first powertrain control mode 442 or the second powertrain control mode 444 according to the determination by the decision-making model in operation 806. The electric motor 322 of the vehicle 100 may then be operated according to the selected mode, including switching between the modes automatically (e.g., without driver intervention). The process 800 may be performed repeatedly to account for changes in the target speed and to account for changes to other states of the vehicle 100.

The above-described processes can be implemented, for example, as a method, as an apparatus that include a memory subsystem, and one or more processors configured to execute instructions stored in the memory subsystem, and as a non-transitory computer-readable medium storing instructions operable to cause one or more processors to perform operations.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. Instructions, or a portion thereof, may be implemented as a special purpose processor, or circuitry, which may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the terminology “example”, “embodiment”, “implementation”, “aspect”, “feature”, or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify”, or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or” unless specified otherwise, or clear from context. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

The above-described aspects, examples, and implementations have been described in order to allow easy understanding of the disclosure are not limiting. On the contrary, the disclosure covers various modifications and equivalent arrangements included within the scope of the appended claims, which scope is to be accorded the broadest interpretation so as to encompass all such modifications and equivalent structure as is permitted under the law.

What is claimed is:

1. A method, comprising:
collecting data from one or more systems of a vehicle, wherein the vehicle comprises a battery;
obtaining a navigation map that represents a vehicle transportation network in a computer-interpretable form;
determining a route for the vehicle;
determining a target speed for travel of the vehicle along the route based on the navigation map;
determining a state of the vehicle, wherein the state of the vehicle comprises the target speed;
determining, using a decision-making model, whether to use a first a powertrain control mode or a second powertrain control mode based on the state of the vehicle, wherein the second powertrain control mode reduces a rate of discharge of the battery as compared to the first powertrain control mode; and
setting the vehicle to use one of the first powertrain control mode or the second powertrain control mode according to the determination by the decision-making model.

2. The method of claim 1, wherein the route for the vehicle is a planned route that is obtained from a navigation system of the vehicle.

3. The method of claim 1, wherein the route for the vehicle is a predicted route that is determined based on the navigation map.

4. The method of claim 1, wherein determining the target speed for the vehicle includes identifying one or more locations along the route, identifying expected speed information for the one or more locations along the route, and calculating the target speed based on the expected speed information for the one or more locations along the route.

5. The method of claim 4, wherein determining the target speed for the vehicle further includes determining traversal probabilities indicating a likelihood that the vehicle will traverse each of the one or more locations along the route, wherein calculating the target speed is further based on the traversal probabilities for the one or more locations along the route.

6. The method of claim 1, wherein the first powertrain control mode includes a first accelerator input-output mapping, the second powertrain control mode includes a second accelerator input-output mapping that differs from the first accelerator input-output mapping.

7. The method of claim 1, wherein the decision-making model is configured to determine whether to use the first a powertrain control mode or the second powertrain control mode based in part on a performance cost function that utilizes a difference between the target speed and a current speed of the vehicle as an input.

8. The method of claim 7, wherein the decision-making model is a multi-objective Markov decision process (MOMDP).

9. An apparatus, comprising:
a memory subsystem; and
one or more processors configured to execute instructions stored in the memory subsystem to:
collect data from one or more systems of a vehicle, wherein the vehicle comprises a battery,
obtain a navigation map that represents a vehicle transportation network in a computer-interpretable form,
determine a route for the vehicle,
determine a target speed for travel of the vehicle along the route based on the navigation map,
determine a state of the vehicle, wherein the state of the vehicle comprises the target speed,
determine, by a decision-making model, whether to use a first a powertrain control mode or a second powertrain control mode based on the state of the vehicle, wherein the second powertrain control mode reduces a rate of discharge of the battery as compared to the first powertrain control mode, and
set the vehicle to use one of the first powertrain control mode or the second powertrain control mode according to the determination by the decision-making model.

10. The apparatus of claim 9, wherein the route for the vehicle is one of a planned route that is obtained from a navigation system of the vehicle or a predicted route that is determined based on the navigation map.

11. The apparatus of claim 9, wherein the determination of the target speed for the vehicle includes identification of one or more locations along the route, identification of expected speed information for the one or more locations along the route, and calculation the target speed based on the expected speed information for the one or more locations along the route.

12. The apparatus of claim 11, wherein the determinations of the target speed for the vehicle further includes determining traversal probabilities indicating a likelihood that the vehicle will traverse each of the one or more locations along the route, wherein calculating the target speed is further based on the traversal probabilities for the one or more locations along the route.

13. The apparatus of claim 9, wherein the first powertrain control mode includes a first accelerator input-output mapping, the second powertrain control mode includes a second accelerator input-output mapping that differs from the first accelerator input-output mapping.

14. The apparatus of claim 9 wherein the decision-making model is configured to determine whether to use the first a powertrain control mode or the second powertrain control mode based in part on a performance cost function that utilizes a difference between the target speed and a current speed of the vehicle as an input.

15. A non-transitory computer-readable storage medium storing instructions operable to cause one or more processors to perform operations comprising:
collecting data from one or more systems of a vehicle, wherein the vehicle comprises a battery;
obtaining a navigation map that represents a vehicle transportation network in a computer-interpretable form;
determining a route for the vehicle;
determining a target speed for travel of the vehicle along the route based on the navigation map;
determining a state of the vehicle, wherein the state of the vehicle comprises the target speed;
determining, using a decision-making model, whether to use a first a powertrain control mode or a second powertrain control mode based on the state of the vehicle, wherein the second powertrain control mode reduces a rate of discharge of the battery as compared to the first powertrain control mode; and
setting the vehicle to use one of the first powertrain control mode or the second powertrain control mode according to the determination by the decision-making model.

16. The non-transitory computer-readable storage medium of claim 15, wherein the route for the vehicle is one of a planned route that is obtained from a navigation system of the vehicle or a predicted route that is determined based on the navigation map.

17. The non-transitory computer-readable storage medium of claim 15, wherein determining the target speed for the vehicle includes identifying one or more locations along the route, identifying expected speed information for the one or more locations along the route, and calculating the target speed based on the expected speed information for the one or more locations along the route.

18. The non-transitory computer-readable storage medium of claim 17, wherein determining the target speed for the vehicle further includes determining traversal probabilities indicating a likelihood that the vehicle will traverse each of the one or more locations along the route, wherein calculating the target speed is further based on the traversal probabilities for the one or more locations along the route.

19. The non-transitory computer-readable storage medium of claim 15, wherein the first powertrain control mode includes a first accelerator input-output mapping, the second powertrain control mode includes a second accelerator input-output mapping that differs from the first accelerator input-output mapping.

20. The non-transitory computer-readable storage medium of claim 15, wherein the decision-making model is configured to determine whether to use the first a powertrain control mode or the second powertrain control mode based in part on a performance cost function that utilizes a difference between the target speed and a current speed of the vehicle as an input.
